(19) United States
(12) Patent Application Publication
(10) Pub. No.: US 2024/0214413 A1
(43) Pub. Date: Jun. 27, 2024

(54) CYBER-HARDENING USING ADVERSARIAL SIMULATED ATTACKING AND DEFENDER SYSTEMS AND MACHINE LEARNING

(71) Applicant: International Business Machines Corporation, Armonk, NY (US)

(72) Inventors: Juan Pablo Parga Jimenez, Guadalajara (MX); Humberto Orozco Cervantes, Tonalá (MX); Jose Ramon Navarro Marquez, Zapopan (MX)

(21) Appl. No.: 18/086,439

(22) Filed: Dec. 21, 2022

(51) Int. Cl. H04L 9/40; G06N 7/08; H04L 41/16

(52) U.S. Cl. CPC H04L 63/145; G06N 7/08; H04L 41/16

(57) ABSTRACT

In one general embodiment, a computer-implemented method includes applying a plurality of known cyber-attack techniques and variations thereof against a simulated defender system using a simulated attacking system. Known cyber-attack defense techniques are applied to the defender system. Instances of the defender system are logged in association with various combinations of respective cyber-attack techniques, various cyber-attack defense techniques, simulated system configurations, and simulated system outcomes as training instances. A machine learning model is trained using the logged training instances. A production product configuration is input to the trained machine learning model. Information related to cyber-hardening of the production product is output from the trained machine learning model.

### BACKGROUND

The present invention relates to computer system defense, and more specifically, this invention relates to enhancing cyber-attack inhibition and resilience for computer systems based on a recognition model trained by two adversarial systems that compete in a simulated environment.

Cyber-attacks are currently one of the biggest problems for information systems. Statistics show that cyber-attacks have increased over 5,000% over the last decade, and the trend continues to go up. The costs of cyber-attacks have also increased significantly, and is estimated to reach up to $10.5 trillion in 2025.

Cyber-attacks on all businesses, but particularly small to medium sized businesses, are becoming more frequent, targeted, and complex. According to some reports, 43% of cyber-attacks are aimed at small businesses, but only 14% of small businesses are prepared to defend themselves.

### SUMMARY

A computer-implemented method, in accordance with one embodiment, includes applying a plurality of known cyber-attack techniques and variations thereof against a simulated defender system using a simulated attacking system. Known cyber-attack defense techniques are applied to the defender system. Instances of the defender system are logged in association with various combinations of respective cyber-attack techniques, various cyber-attack defense techniques, simulated system configurations, and simulated system outcomes as training instances. A machine learning model is trained using the logged training instances. A production product configuration is input to the trained machine learning model. Information related to cyber-hardening of the production product is output from the trained machine learning model.

A computer-implemented method, in accordance with another embodiment, includes, in a simulated computing environment having a simulated attacking system and a simulated defender system, performing the following operations in a repeating sequence until a cyber-attack simulation sequence is complete: preparing a next cyber-attack, applying the next cyber-attack to the defender system, determining an outcome of the cyber-attack on the defender system, updating a defense mechanism of the defender system in response to the outcome of the cyber-attack, and logging instances of the defender system in association with various combinations of respective cyber-attack techniques, various cyber-attack defense techniques, simulated system configurations, and simulated system outcomes as training instances. In response to completing the cyber-attack simulation sequence, a machine learning model is trained using the training instances. The machine learning model is stored, and may be used to improve cyber-attack resistance of a computer system.

A computer program product for cyber-hardening using adversarial machine learning includes one or more computer readable storage media, and program instructions collectively stored on the one or more computer readable storage media. The program instructions comprise program instructions to perform either or both of the foregoing methods.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 depicts a system for cyber-hardening using adversarial simulated systems and machine learning, in accordance with one embodiment.

FIG. 4 is a flowchart of a method, in accordance with one embodiment.

FIG. 5 is a flowchart of a method, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for a cyber-attack inhibition and resilience (defender) product and methodology for computer systems based on two adversary systems that compete in a zero-sum game to train a recognition model in a virtual environment that can be shared with systems having similar configurations and/or conditions.

In one general embodiment, a computer-implemented method includes applying a plurality of known cyber-attack techniques and variations thereof against a simulated defender system using a simulated attacking system. Known cyber-attack defense techniques are applied to the defender system. Instances of the defender system are logged in association with various combinations of respective cyber-attack techniques, various cyber-attack defense techniques, simulated system configurations, and simulated system outcomes as training instances. A machine learning model is trained using the logged training instances. A production product configuration is input to the trained machine learning model. Information related to cyber-hardening of the production product is output from the trained machine learning model.

In another general embodiment, a computer-implemented method includes, in a simulated computing environment having a simulated attacking system and a simulated defender system, performing the following operations in a repeating sequence until a cyber-attack simulation sequence is complete: preparing a next cyber-attack, applying the next cyber-attack to the defender system, determining an outcome of the cyber-attack on the defender system, updating a defense mechanism of the defender system in response to the outcome of the cyber-attack, and logging instances of the defender system in association with various combinations of respective cyber-attack techniques, various cyber-attack defense techniques, simulated system configurations, and simulated system outcomes as training instances. In response to completing the cyber-attack simulation sequence, a machine learning model is trained using the training instances. The machine learning model is stored, and may be used to improve cyber-attack resistance of a computer system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for cyber-hardening using adversarial simulated systems and machine learning in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

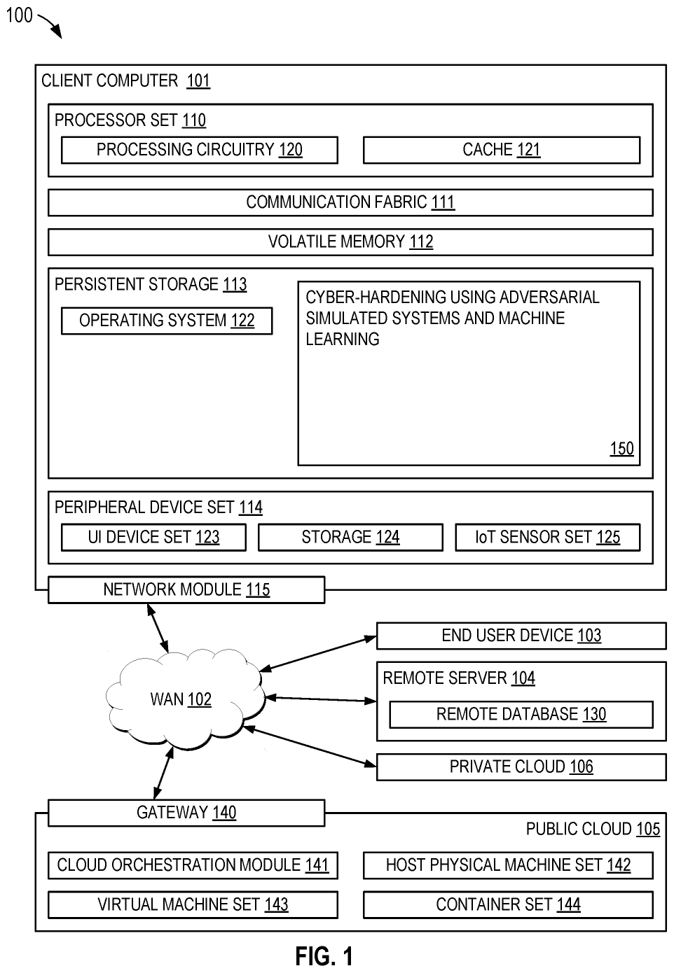

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

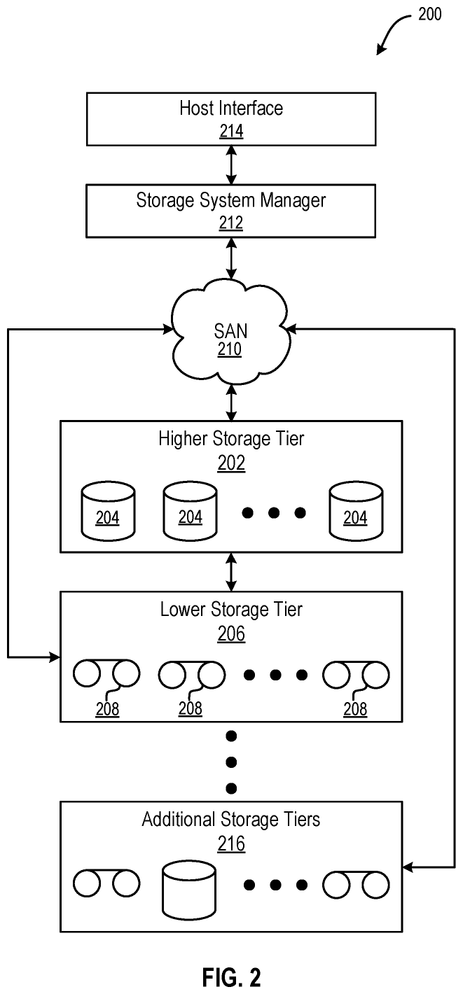

Now referring to FIG. 2, a storage system 200 is shown, according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

Of course, this logic may be implemented as a method on any device and/or system or as a computer program product, according to various embodiments.

As noted above, cyber-attacks are currently one of the largest problems for all types of computer systems, especially information systems. Methodology presented herein, in accordance with various embodiments, aims to help to close the gap between defense and attack by using two adversary systems that compete in a zero-sum game to train a recognition model in a virtual environment. The trained learning model may then be used to harden an actual product against cyber-attacks, e.g., a production computer system, a production software product, etc.

In preferred embodiments, many variations of cyber-attacks and defensive actions are performed sequentially, preferably with one or more modifications made to the cyber-attack and/or defense technique during each iteration to change the outcome. By implementing a learning methodology for the cyber-attack and correction of vulnerabilities, based on the experience gained, the attacking system is able to improve its attack and the defender system is able to improve its defense mechanisms, and generate a model that can be shared to other teams and systems having similar configurations and/or conditions, without the need to disclose or compromise the information of the system.

Both the attacking system and the defender system preferably use techniques such as chaos engineering and autolearning techniques to attack and defend, based on the infrastructure, databases, languages, among other things to generate a learning model that can be shared for use with similar systems to improve defense, thereby hardening the system or software against cyber-attacks. This will increase the level of security in products having similar infrastructure, programming languages, databases, servers, etc.

In preferred embodiments, the attacking system uses known cyber-attacks and fuzzing algorithms to try to break security or generate instability in a defender system, e.g., a system hosting a database. The defender system uses strategies and resource management in an attempt to remain resilient. Preferably, both attacker and defender models are trained automatically, thereby generating a self-testing model that can later be shared for use in hardening similar systems (e.g., instances, product/development environments, etc.) from cyber-attack, e.g., by attempting to recreate the stability of the auto test systems. Depending on the strategy, the model can be applied to other systems and/or shared in the form of configuration files, selection of a particular version of software, application of patches, etc.

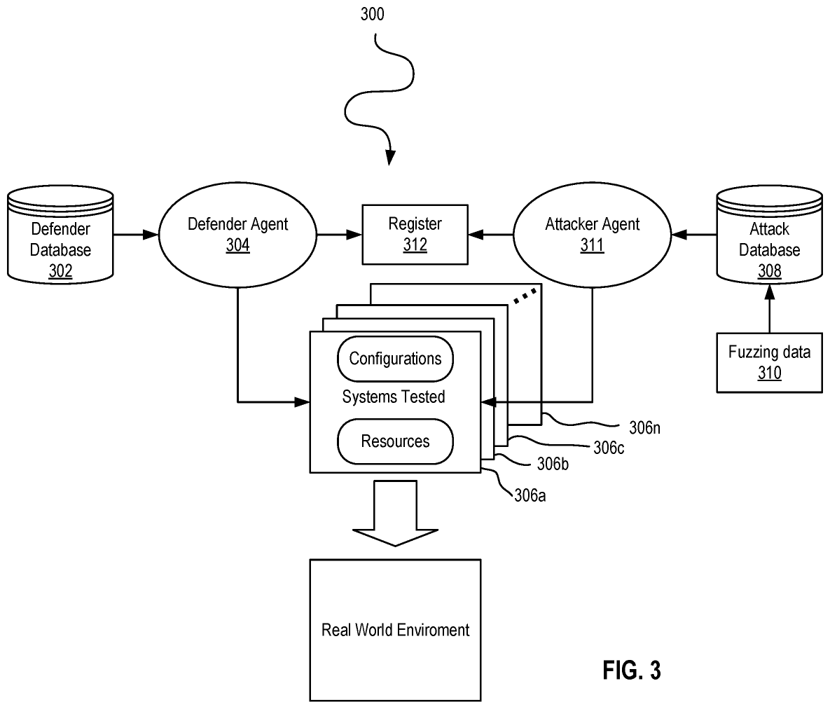

FIG. 3 depicts a system 300 for cyber-hardening using adversarial simulated systems and machine learning, in accordance with one embodiment. As an option, the present system 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

As shown in FIG. 3, a defender database 302 includes known active vulnerabilities corresponding to particular system configurations, software modules, etc. An initial database is preferably created before testing begins. Moreover, the database 302 can be supplemented anytime with vulnerability information from any source. For example, the database 302 can be supplemented with vulnerabilities identified by a dynamic or static vulnerability scanning product such as AppScan sold by HCL Software, having a place of business at 3415 Wake Forest Rd, Raleigh, North Carolina, 27609, United States. Moreover, as simulated cyber-attacks are performed, information about successful and unsuccessful defense, such as the point of failure in an unsuccessful cyber-attack, can be added to the database 302 in an effort to improve the defender system's resistance to cyber-attack.

A defender agent 304 creates a simulated defending system having a particular hardware and/or software configuration. The defender agent 304 may also specify computing resources available to the defending system. The simulated defending system may be implemented in a container 306a. Moreover, multiple simulated defending systems may be implemented in a plurality of containers 306a, 306b, 306c . . . 306n to enable running multiple simulations in parallel. The defending systems simulated in the various containers may have the same configurations and/or resources in all containers, or may have different configurations and/or resources in respective containers, e.g., to determine if a particular configuration is more resistant to an attack than another configuration.

An attack database 308 stores information that allows creation of known types of cyber-attacks. Moreover, fuzzing data 310 of any known type may be provided to allow creation of variations of the known types of cyber-attacks.

An attacker agent 311 creates a simulated attacker system or equivalently, cyber-attack actions that would be performed by such an attacker system.

The cyber-attack(s) are applied to the simulated defending systems running in the containers 306a-306n. Results of the cyber-attacks may be logged in a results register 312, which may include one or more databases. Such results may include any relevant information about the simulations, such as defending system configurations that failed a given cyber-attack, defending system configurations that successfully thwarted a particular cyber-attack, which cyber-attacks succeeded and which failed, etc.

The information in the results register 312 may then be used to train a machine learning model, which in turn may be used to cyber-harden a computer system and/or software product (collectively, production product) in the real world.

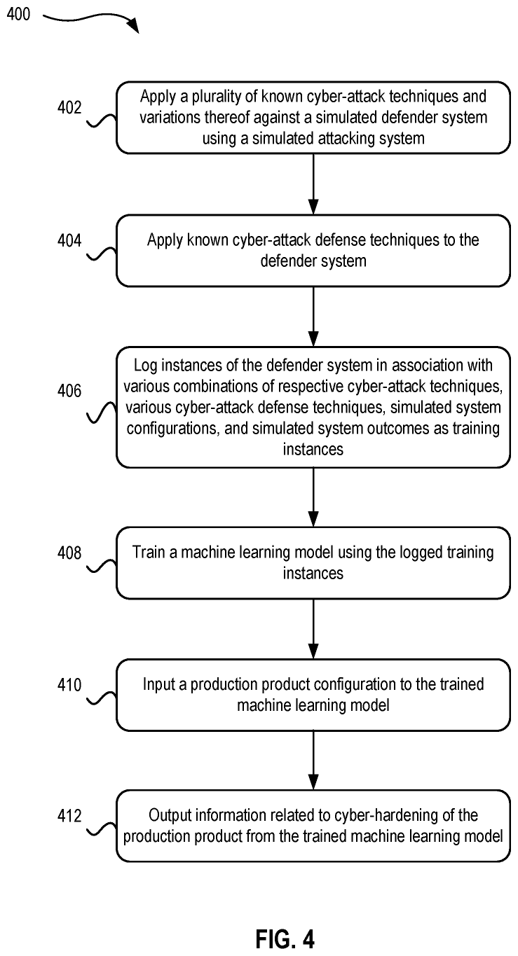

Now referring to FIG. 4, a flowchart of a method 400 is shown according to one embodiment. The method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, in which a plurality of known cyber-attack techniques and variations thereof are applied against a simulated defender system using a simulated attacking system. The cyber-attacks may be applied to test some or all portions of the simulated defender system, such as one or more of: its hardware configuration, its software configuration, the configuration of resources allocated to the defender system, etc.

As noted above, agents may be used to generate the simulated systems. In other approaches, the simulated systems may be created in any other way that would become apparent to one skilled in the art after reading the present disclosure.

Moreover, multiple cyber-attack simulations may be performed in parallel, e.g., using containers, as noted above. For example, a plurality of unique cyber-attack techniques and/or variations thereof may be applied against a plurality of simulated defender systems in parallel using containers.

The variations of the known cyber-attack techniques may be created in any way that would become apparent to one skilled in the art after reading the present disclosure. In some embodiments, the variations of the known cyber-attack techniques are the known cyber-attack techniques modified using fuzzing, e.g., as noted above. In other embodiments, variations may be created by a human.

For the implementation of the cyber-attack mechanisms, the method 400 can use existing technologies such as chaos engineering. Accordingly, in some embodiments, at least some of the known cyber-attack techniques are modified using chaos engineering. Chaos engineering includes the methodology of experimenting on an application of software in order to build confidence in the system's capability to withstand turbulent and unexpected conditions. The known cyber-attack techniques modified via chaos engineering can be used to induce unexpected errors in the defending system, resulting in knowledge that can be used to achieve resilience against infrastructure failures, network failures, and application failures. For example, one type of cyber-attack may be programmed to randomly terminate instances to test whether the defending system is resilient to instance failures.

In preferred embodiments, the attacking system is provided with a Uniform Resource Locator (URL) of the defender system and a list of internal paths associated with the defender system against which to direct the known cyber-attack techniques and variations thereof.

In some approaches, machine learning may be used to create variations of known cyber-attack techniques. In one approach, the following learning procedure may be used to train a machine learning model to create variations on known cyber-attack techniques. A database that contains key elements related to cyber-attacks is obtained. The paths to attack (such as URL of defender system) is provided. All possible application internal paths and shortcuts are determined. The database is used to generate and execute cyber-attacks directed to all the internal paths. The database may be updated, e.g., in response to successful cyber-attacks.

In this way, where the database has been updated with information from previous cyber-attacks, the attacking system is trained to improve cyber-attacks on the defender system based on the outcome of previous cyber-attacks conducted during the performance of the method.

In operation 404, known cyber-attack defense techniques are applied to the defender system. Any defense techniques that would become apparent to one skilled in the art after reading the present disclosure may be used. The known cyber-attack defense techniques may be retrieved from a defender database (e.g., 302 of FIG. 3). Moreover, modified versions of the known cyber-attack defense techniques may be created and used.

Modifications to known cyber-attack defense techniques may be created using an automatic vulnerability detection and repair by learning technique of known type. In one embodiment, cyber-attack defense techniques, including variations thereof, are created by a defender agent (e.g., 304 of FIG. 3).

Modifications to known cyber-attack defense techniques may be created using a machine learning model that learns from past cyber-attacks to improve defensive mechanisms. For example, the learning model may take as input an instance reflecting the state of the defender system at the time of a successful cyber-attack, the parameters of a successful cyber-attack, etc. and output a modified defense technique that remedies the vulnerability that led to the successful cyber-attack. This feature is especially useful in simulations in which the cyber-attacks are created using fuzzing and chaos engineering, as the defense mechanism learns and adapts over time to handle many more types of cyber-attacks.

In one approach, the following learning procedure may be part of a machine learning model to create variations on known cyber-attack defense techniques. A database for active vulnerabilities is obtained and used. The information in the database can be used in coordination with known vulnerability scanning techniques such as AppScan or any other static/dynamic scanning solution. Special steps and/or tailored (to the defender system configuration) steps to detect a particular vulnerability and its proper defense mechanism may be provided, such as remove an XSS, SQL Injection. For example, to remove an SQL Injection, a tailored method to do a sanity method may be created to exclude bad characters. Based on the defined defense mechanism, the code/configurations corresponding thereto are added to the proper repository, e.g., by creating a pull request or any other procedure to manage the code/configuration changes. In some approaches, the changes go through a human review process.

In operation 406, instances of the defender system are logged in association with various combinations of respective cyber-attack techniques, various cyber-attack defense techniques, simulated system configurations, and simulated system outcomes as training instances. The logging may be to a database, such as register 312 of FIG. 3.

In operation 408, a machine learning model is trained using the logged training instances. Any known technique to train the model that would become apparent to one skilled in the art after reading the present disclosure may be adapted for use.

In operation 410, a production product configuration is input to the trained machine learning model. The production product may be a computer system and/or software product in the real world, in some approaches.

In operation 412, information related to cyber-hardening of the production product is output from the trained machine learning model. Illustrative information output from the trained machine learning model may include one or more of: a set of modified production product configurations, a set of cyber-attack technique vulnerabilities, and a set of cyber-attack defense techniques to deploy on the production product.

The output information may in turn be used to improve the configuration of the production product to cyber-harden the production product against cyber-attacks.

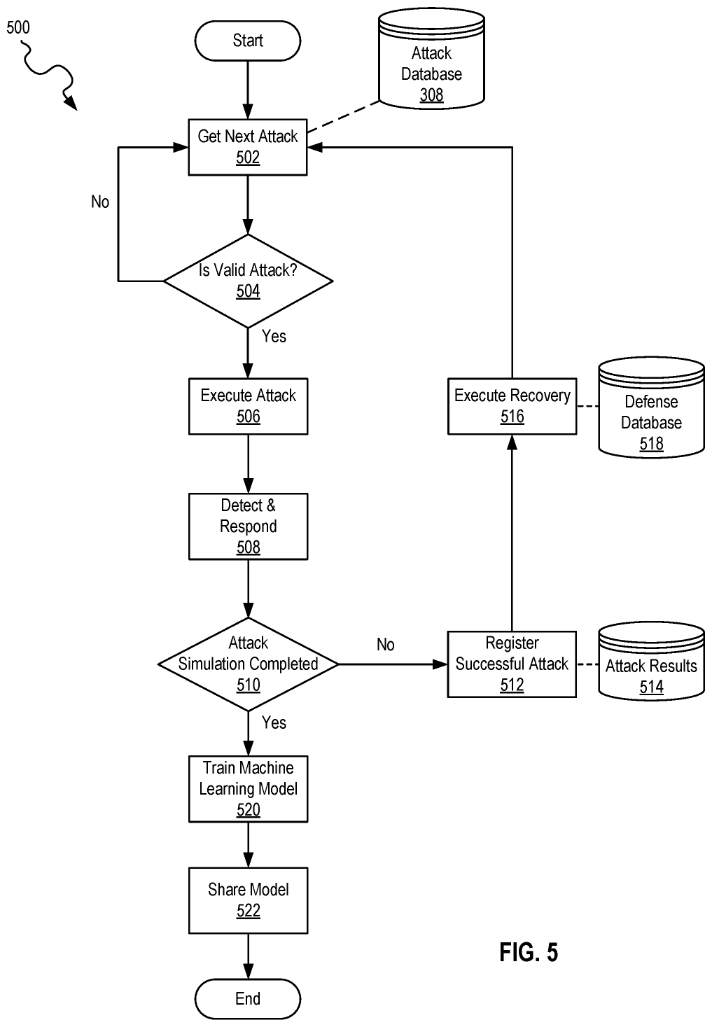

Now referring to FIG. 5, a flowchart of a method 500 is shown, according to one embodiment. The method 500 may be performed in accordance with the present invention in any of the environments depicted in FIGS. 1-4, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, in a simulated computing environment having a simulated attacking system and a simulated defender system, various operations are performed in a repeating sequence until a cyber-attack simulation sequence is complete. Moreover, as noted above, multiple sequences may be run in parallel, e.g., using containers.

In operation 502, a next cyber-attack is prepared. Note that in the first iteration, the ‘next’ cyber-attack may be the first cyber-attack in the first iteration, and then the next cyber-attack may be a variation on the first cyber-attack with adjusted parameters, another different type of cyber-attack, and so on so that many different cyber-attacks are performed as the simulation iterates through the loop toward completion of the simulation.

The next cyber-attack may be a known type of cyber-attack retrieved from an attack database 308, e.g., as described above. The next cyber-attack may be a variation of a known type of cyber-attack, e.g., created according to the methodology presented above.

As described above, preparing the next cyber-attack may include altering a previously-executed cyber-attack in the cyber-attack simulation sequence based on the outcome of a previously-attempted cyber-attack in an effort to improve the effectiveness of the cyber-attack.

As described above, preparing the next cyber-attack may include using a Uniform Resource Locator (URL) of the defender system and a list of internal paths associated with the defender system against which to direct the cyber-attack.

As described above, preparing the next cyber-attack may include creating a modification of a known cyber-attack technique using fuzzing.

As described above, preparing the next cyber-attack may include creating a modification of a known cyber-attack technique using chaos engineering.

As described above, preparing the next cyber-attack may include training the attacking system to improve cyber-attacks on the defender system based on the outcome of previous cyber-attacks conducted during performance of the cyber-attack simulation sequence.

At decision 504, a determination is made as to whether the type of cyber-attack is valid for the configuration of the defending system. If the cyber-attack is not valid, e.g., incompatible with the configuration of the defending system, the process returns to operation 502. If the cyber-attack is valid, the next cyber-attack is applied to the defender system in operation 506.

In operation 508, the defending system detects the cyber-attack and responds to the cyber-attack using defensive techniques.

In operation 510, the outcome of the cyber-attack on the defender system is determined. If the cyber-attack was successful, and/or there are additional cyber-attacks to apply to the defending system, the cyber-attack simulation follows the “no” path and continues through the loop for application of more cyber-attacks. In some embodiments, the goal of the method 500 is to achieve a situation where the defending system is able to successfully thwart all cyber-attacks and variations thereof. To that end, successful cyber-attacks may be reapplied in operation 506 in later iterations, but with updated defense techniques applied to the defending system, as will soon become apparent.

In operation 512, a successful cyber-attack is registered. Results corresponding to the cyber-attack may be stored in an attack results database 514, which may be used to train the cyber-attack technique model to improve the cyber-attacks based on the success.

In operation 516, a defense mechanism of the defender system is updated in response to the outcome of the cyber-attack, in an effort to successfully defend against that particular cyber-attack in the future. Results corresponding to successful and/or unsuccessful defense attempts may be stored in a defense database 518, which may be used to train the defense technique model to improve resistance to successful cyber-attacks.

Likewise, in operation 516, the defending system may attempt to recover from a successful cyber-attack, and the results of the attempt to recover may be stored in the defense database 308.

Note that databases 514 and/or 518 may log instances of the defender system in association with various combinations of respective cyber-attack techniques, various cyber-attack defense techniques, simulated system configurations, and simulated system outcomes as training instances for training a machine learning model (see operation 520, below).

The process returns to operation 502, where the next cyber-attack is selected, and the operations in the loop are performed until a predefined condition is met. The predefined condition may be any condition that would become apparent to one skilled in the art upon reading the present disclosure. Illustrative conditions may include the occurrence of no more successful cyber-attacks, even after successful cyber-attacks are reapplied; passing of a predetermined amount of time; reaching a predefined number of iterations; a manual stop request from a user; all known cyber-attack techniques have been tried at least once; etc.

In operation 520, in response to completing the cyber-attack simulation sequence, a machine learning model is trained using the training instances. The trained machine learning model may be stored in memory.

In operation 522, the machine learning model is shared, where it can be used to improve cyber-attack resistance of a computer system, such as the hardware configuration thereof, a software product thereon, etc. In some embodiments, using the machine learning model to improve cyber-attack resistance of a computer system is based on output thereof selected from the group consisting of: a set of modified computer system configurations, a set of cyber-attack technique vulnerabilities, and a set of cyber-attack defense techniques to deploy on the computer system.

Any of the foregoing methodologies may be adapted for simulation and/or cyber-hardening in the following attacking and defending situations:
Adaptative response: capacity optimization for better and assertive responses on adversary conditions.
Analytic motorization: increases the possibilities to be able to detect unfavorable conditions and show the reach.
Coordinate protection: the attacker should overcome different types of defenses.
Deceive: deceive or confuse the attacker and hide critical files from it.
Diversity: if a failure was to present on the repeated common components, they may limit the loss of relevant functions.
Dynamic positioning: limits the attacker's capacity to locate, destroy or damage the mission or commercial assets.
Dynamic representation: discovers patterns or tendencies on the attacker's behavior, supporting the situational conscience.
No persistency: facilitates an environment where the attacker's intrusion diminishes.
Privilege restriction: limits the benefits, depending on the users' particularities and system elements.
Realignment: decreases the enterprise attack field.
Redundancy: decreases the results generated by the loss of information or services.
Segmentation: restricts the possible target group where malware can easily be propagated.
Proven integrity: identifies the attack attempts to provide data of hardware or software that may be affected, same as the modifications or successful fabrications.
Unpredictability: presents in a sudden and surprising way and cannot avoid what the attacker may find in regards to systems protections.

In one example of a use case, consider an application development scenario. The application development process is split into two instances, development and release. The development environment is tested via manual and automated testing techniques to run correctly and then the instance is cloned in a production environment (release+configurations). Prior to the methodology presented herein, it was difficult, if not impossible, to recreate the same ‘real world’ configurations that the application will have upon deployment. This is due to databases, services or other artifacts that may or may not be represented in the clone in production. In contrast, the present methodology estimates possible parameters of the production environment and uses this information to attack a simulated environment in an automated way to have a better compatibility between development and production environments. The system can use the cyber-attack's results and apply the defense mechanism, such as protecting data, resources and general information. At the end, the attack and defense model may be exported in a known security format/report that can be shared with other teams.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
applying a plurality of known cyber-attack techniques and variations thereof against a simulated defender system using a simulated attacking system;
applying known cyber-attack defense techniques to the defender system;
logging instances of the defender system in association with various combinations of respective cyber-attack techniques, various cyber-attack defense techniques, simulated system configurations, and simulated system outcomes as training instances;
training a machine learning model using the logged training instances;
inputting a production product configuration to the trained machine learning model; and
outputting, from the trained machine learning model, information related to cyber-hardening of the production product.

2. The computer-implemented method of claim 1, wherein the information output from the trained machine learning model is selected from the group consisting of:
a set of modified production product configurations, a set of cyber-attack technique vulnerabilities, and a set of cyber-attack defense techniques to deploy on the production product.

3. The computer-implemented method of claim 1, wherein the attacking system is provided a Uniform Resource Locator (URL) of the defender system and a list of internal paths associated with the defender system against which to direct the known cyber-attack techniques and variations thereof.

4. The computer-implemented method of claim 1, wherein the variations of the known cyber-attack techniques are the known cyber-attack techniques modified using fuzzing.

5. The computer-implemented method of claim 1, wherein at least some of the known cyber-attack techniques are modified using chaos engineering.

6. The computer-implemented method of claim 1, comprising training the attacking system to improve cyber-attacks on the defender system based on the outcome of previous cyber-attacks conducted during performance of the method.

7. The computer-implemented method of claim 1, wherein a plurality of unique cyber-attack techniques and/or variations thereof are applied against a plurality of simulated defender systems in parallel using containers.

8. A computer-implemented method, comprising:
in a simulated computing environment having a simulated attacking system and a simulated defender system, performing the following operations in a repeating sequence until a cyber-attack simulation sequence is complete:
preparing a next cyber-attack,
applying the next cyber-attack to the defender system,
determining an outcome of the cyber-attack on the defender system,
updating a defense mechanism of the defender system in response to the outcome of the cyber-attack, and
logging instances of the defender system in association with various combinations of respective cyber-attack techniques, various cyber-attack defense techniques, simulated system configurations, and simulated system outcomes as training instances;
in response to completing the cyber-attack simulation sequence, training a machine learning model using the training instances;
storing the machine learning model; and
using the machine learning model to improve cyber-attack resistance of a computer system.

9. The computer-implemented method of claim 8, wherein preparing the next cyber-attack includes altering a previously-executed cyber-attack in the cyber-attack simulation sequence based on the outcome of a previously-attempted cyber-attack in an effort to improve effectiveness of the cyber-attack.

10. The computer-implemented method of claim 8, wherein preparing the next cyber-attack includes using a Uniform Resource Locator (URL) of the defender system and a list of internal paths associated with the defender system against which to direct the cyber-attack.

11. The computer-implemented method of claim 8, wherein preparing the next cyber-attack includes creating a modification of a known cyber-attack technique using fuzzing.

12. The computer-implemented method of claim 8, wherein preparing the next cyber-attack includes creating a modification of a known cyber-attack technique using chaos engineering.

13. The computer-implemented method of claim 8, wherein preparing the next cyber-attack includes training the attacking system to improve cyber-attacks on the defender system based on the outcome of previous cyber-attacks conducted during performance of the cyber-attack simulation sequence.

14. The computer-implemented method of claim 8, wherein using the machine learning model to improve cyber-attack resistance of a computer system is based on output thereof selected from the group consisting of: a set of modified computer system configurations, a set of cyber-attack technique vulnerabilities, and a set of cyber-attack defense techniques to deploy on the computer system.

15. The computer-implemented method of claim 8, wherein the simulated computing environment has a plurality of simulated attacking systems and a plurality of simulated defender systems, wherein a plurality of unique cyber-attack techniques and/or variations thereof are applied against the plurality of simulated defender systems in parallel using containers.

16. A computer program product for cyber-hardening using adversarial machine learning, the computer program product comprising:
one or more computer readable storage media, and program instructions collectively stored on the one or more computer readable storage media, the program instructions comprising:
program instructions to apply a plurality of known cyber-attack techniques and variations thereof against a simulated defender system using a simulated attacking system;
program instructions to apply known cyber-attack defense techniques to the defender system;
program instructions to log instances of the defender system in association with various combinations of respective cyber-attack techniques, various cyber-attack defense techniques, simulated system configurations, and simulated system outcomes as training instances;
program instructions to train a machine learning model using the logged training instances;
program instructions to input production product configurations to the trained machine learning model; and
program instructions to output, from the trained machine learning model, information related to cyber-hardening of the production product.

17. The computer program product of claim 16, wherein the information output from the trained machine learning model is selected from the group consisting of: a set of modified production product configurations, a set of cyber-attack technique vulnerabilities, and a set of cyber-attack defense techniques to deploy on the production product.

18. The computer program product of claim 16, wherein the attacking system is provided a Uniform Resource Locator (URL) of the defender system and a list of internal paths associated with the defender system against which to direct the known cyber-attack techniques and variations thereof.

19. The computer program product of claim 16, wherein the variations of the known cyber-attack techniques are modified using fuzzing.

20. The computer program product of claim 16, wherein at least some of the known cyber-attack techniques are modified using chaos engineering.
